(19) United States
(12) Patent Application Publication
(10) Pub. No.: US 2007/0122320 A1
(43) Pub. Date: May 31, 2007

(54) Air purification system and method

(76) Inventors: Timothy Allen Pletcher, Eastampton, NJ (US); Steven Warshawsky, Staten Island, NY (US); Joseph Thomas McGinn, Flemington, NJ (US); David Keller, Newton, PA (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/595,405

(22) Filed: Nov. 9, 2006

Related U.S. Application Data
(60) Provisional application No. 60/734,867, filed on Nov. 9, 2005.

(51) Int. Cl. B03C 3/00

(52) U.S. Cl. 422/186.07; 96/15

(57) ABSTRACT

The present invention relates to a Wet Electrostatic Precipitator Air (WEPA) Purifier and purification method capable of stand-alone operation as the principal air purification system, particularly in military applications. This system is intended to supply small military units within a temporary structure clean, threat-free fresh air for periods up to 12 months without maintenance. The WEPA Purifier is configured to remove and sterilize biological threat particles from an airflow, and further remove and sequester radioactive particulates, thus allowing them to be safely removed at normal maintenance periods. The WEPA Purifier includes a wet electrostatic precipitator filtration element in which particles are charged and collected by a capturing solution flowing over an attracting electrode collection plate. The water is returned by gravity to a reservoir where it is disinfected and captured particles retained in a small, low maintenance, regenerative liquid filter.

### CROSS REFERENCE TO RELATED APPLICATION

This application claims the benefit of U.S. Provisional Application Ser. No. 60/734,867 filed on Nov. 9, 2005. The entire disclosure of U.S. Provisional Application Ser. No. 60/734,867 is incorporated by reference herein.

### FIELD OF THE INVENTION

The present invention relates to a system and method for air purification, and more specifically to a system and method for high efficiency particulate air purification adapted for high volume airflows and high-efficiency particle capture, retention, and destruction.

### BACKGROUND OF THE INVENTION

Personnel deployment into situations where hazardous air particulates may be present is an increasing concern, particularly in military situations. As such, enhanced personnel protection against these hazardous air particulates within temporary and permanent structures is an ever present goal. A growing need exists for enhanced air purification technology to enable the supply of particulate-free air to a ‘clean room,’ such as a permanent facility, a temporary structure, a command tent, a hospital ward, and/or mobile vehicle. Furthermore, there exists a need to augment existing HVAC systems.

Conventional air purification systems utilize High Efficiency Particulate Air (HEPA) filters. Conventionally, within a structure the threat of biological agents are filtered by High Efficiency Particulate Air (HEPA) filters. However, HEPA filters have many disadvantages. Because the HEPA filter lacks the ability for microbe destruction, HEPA-based systems are only able to collect the hazardous particulates in the filter. Continual use of the filter thus leads to a build up of contaminates in the filter, which reduces the efficacy and effectiveness over the lifetime of the filter. Furthermore, the storage of the particulates in the filter forces the operator to periodically replace and/or maintain the filter. Personnel safety and efficacy are comprised by repeated use of the filter, requiring that the filter be decontaminated or replaced periodically. This type of maintenance is dangerous for the individual who may be exposed to the contaminates during replacement of the filter. In sum, conventional HEPA-based systems are able to act only as filter (removing and storing the particulates), and not as a purifier.

In addition, HEPA filters suffer from high power consumption due to large pressure drop across the filter media. Furthermore, as a practical matter, HEPA-based systems cause a significant logistics burden, due to the fact that the filters need to be purchased, stored, transported and maintained for a broad variety of filter elements.

Furthermore, like HEPA filters, conventional traditional wet electrostatic precipitators and Ultra Low Penetration Air (ULPA) filters are designed to merely trap the biological particulates, but are not able to destroy the dangerous particulates.

Accordingly, there is a need in the art for an air purification method and system capable of purifying high volume air flows and for high-efficiency particle removal and destruction.

### SUMMARY OF THE INVENTION

The above-described problems are addressed and a technical solution is achieved in the art by a system and a method for removing hazardous particulates or particles from particulate/particle-laden air entering the system (herein referred to as the “contaminated air”), destroys or contains the hazardous particulates, and produces the purified air (herein referred to as the “purified air”) to the surrounding environment. As used herein, the term “particulate” or “particle” is intended to comprise any material present in the air.

The present invention relates to a Wet Electrostatic Precipitator Air Purifier and purification method (herein, referred to as the “WEPA Purifier” or “WEPA Purification method”) efficiently captures potentially hazardous particulates present in the contaminated air. Once captured, the WEPA Purifier destroys or contains the particulates to avoid re-entrainment into the airflow, thus producing purified air.

According to an embodiment of the present invention, the WEPA Purifier comprises the following primary areas: a pre-conditioning chamber, a wet electrostatic precipitator, a re-circulating solution system, and an air handling system.

According to an embodiment of the present invention, the WEPA Purifier comprises the following components: an air inlet, a large particulate inertial separator, a flow straightener, a wet electrostatic precipitator, an ozone catalyst, a fan, and an air outlet. These components define an airflow path, whereby contaminated air (i.e., the aerosol) enters the air flow path, and purified air exits the path.

The large particulate inertial separator is arranged in fluid connection with the air inlet of the WEPA Purifier and is configured to remove large particulates from the inlet air flow, herein referred to as the “contaminated air.” As used herein, the term “large particulate” is intended to include any particulate having a particle diameter of 50 μm or more. Furthermore, as used herein, the term “small particulate” is intended to include any particulate having a particle diameter of less than 50 μm.

The flow straightener is arranged in fluid communication with the large particulate inertial separator. The flow straightener comprises an array of parallel tubes configured to create a smooth, streamline laminar airflow at the input of the wet electrostatic precipitator subassembly. The wet electrostatic precipitator assembly may comprise any number of modules, adapted to provide filtration of the air. According to an embodiment of the present invention, each module of the wet electrostatic precipitator assembly comprises a particle capture zone which is partitioned in two main sections: a charging section and a collection section. The charging section includes a corona array comprising a plurality of rows of corona discharge electrodes. The collection section includes a grounded wetted collection surface or plate (herein referred to as the “collection plate”) and a field electrode.

A voltage is applied between the corona electrodes and the collection plate creating a corona discharge at each electrode tip. This corona discharge charges each of the particles as they pass through the charging zone. Next, the charged particles pass into the collection zone, where a voltage is applied between the field electrode and the collection plate to drive the charged particles through the air stream to the collection plate, where they are captured in a solution disposed on the surface of the collection plate, herein referred to as the “collection surface.”

According to an embodiment of the present invention, the solution is pumped from a main reservoir to a top end of the collection plate, where it is distributed uniformly across the collection surface. Next, the particles are captured in the solution flowing over the collection surface and transported to the main reservoir. Preferably, the consumable component of the solution is water, thus eliminating the need for the use of a special capturing media.

Advantageously, the WEPA Purifier and purification method of the present invention requires minimal logistical and maintenance-related upkeep. The destruction of the captured threats reduces the maintenance and storage burdens associated with the conventional HEPA systems. More particularly, the WEPA Purifier and related method reduce the risks associated with the threats for hazard free removal, minimize component replacement and maintenance requirements, and robustly operate over a wide range of atmospheric and airflow conditions with minimal power requirements. In addition, the need for consumables (e.g., water, bleach) is minimized, and when necessary, such consumables are readily available from unspecialized stocks.

According to an embodiment of the present invention, the WEPA Purifier and WEPA purification method is scalable to allow for the protection for a wide range and variety of environments. Specifically, the WEPA Purifier may comprise any number of wet electrostatic precipitator modules to accommodate varying airflow requirements, such as those seen in battlefield or emergency situations. The scaleable modular design allows for a plurality of wet electrostatic precipitator modules to be “stacked” in parallel, thus avoiding the need to store and deploy a multiplicity of systems.

Decontamination of biological particles upon capture. Low power consumption. Greater than 99.99% expected particle removal/decontamination efficiency for particles 0.3 microns and greater.

According to an aspect of the present invention, the WEPA Purifier is designed to both remove and destroy particulate threats without the need for a filter, and is therefore referred to as a filterless system. The filterless design allows for constant and continual particulate removal, without the need for the burdensome maintenance associated with conventional systems. For example, the WEPA purifier is capable of providing highly efficient purification over maintenance-free time periods of approximately 12 months. Furthermore, the performance of the filterless WEPA Purifier of the present invention does not degrade as the hazardous material is collected, as is the case with HEPA filters. Advantageously, the WEPA Purifier is capable of continuously and effectively destroying captured biological particulates, resulting in easy, hazard-free disposal of captured material. In addition, the WEPA Purifier requires lower power consumption as compared to conventional systems and may be powered by a conventional battery source, thus allowing for increased portability.

According to an aspect of the present invention, the WEPA Purifier may provide over 99.99% particle removal and destruction efficiency of particulates 0.3 microns and greater. Furthermore, according to an embodiment of the present invention, the WEPA Purifier may operate at a flow rate of approximately 4,000 LPM (140 CFM) and is able to collect particles, at a reduced efficiency, down to approximately 50 nanometers.

The WEPA Purifier will provide enhanced protection to military personnel against hazardous air particulates in temporary field structures such as tents or modular buildings. The WEPA Purifier immediately destroys threats upon capture, by collecting all particles in a 0.5% sodium hypochlorite (bleach) and water solution. According to the present invention, the water or water/bleach solution acts as the capturing media, eliminating the need for special filter media.

### BRIEF DESCRIPTION OF THE DRAWINGS

The present invention will be more readily understood from the detailed description of exemplary embodiments presented below considered in conjunction with the attached drawings, of which:

FIG. 1 depicts a component diagram of an exemplary wet electrostatic precipitator air purifier, according to an embodiment of the present invention;

FIG. 2 is a side perspective view of an exemplary single module WEPA purifier, according to an embodiment of the present invention;

FIG. 3 illustrates a side perspective view of an exemplary scalable WEPA purifier comprising a plurality of electrostatic precipitator modules, according to an embodiment of the present invention;

FIG. 4 depicts a modeling of particle activity experienced in the wet electrostatic precipitator, according to an embodiment of the present invention;

FIG. 5 depicts a graphical representation of wet electrostatic trajectories for different size particles, according to an embodiment of the present invention; and

FIG. 6 depicts a graph showing estimated purification efficiency versus particle size, according to an embodiment of the present invention.

It is to be understood that the attached drawings are for purposes of illustrating the concepts of the invention and may not be to scale.

### DETAILED DESCRIPTION OF THE INVENTION

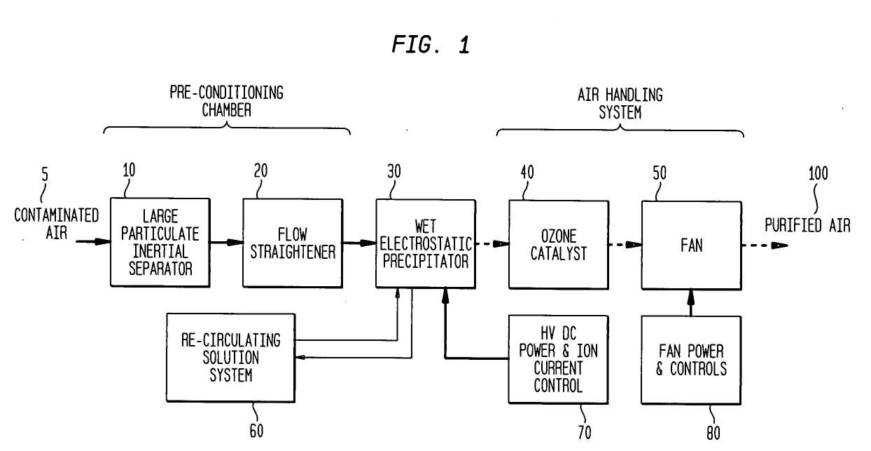

The present invention relates to a system and method for purifying contaminated air. FIG. 1 depicts an exemplary WEPA Purifier and WEPA purification method, according to an embodiment of the present invention. The WEPA Purifier and WEPA purification method 1, collectively referred to herein as the “WEPA Purifier,” comprises an air inlet, a pre-conditioning chamber; a Wet Electrostatic Precipitator 30; a re-circulating solution system 60, an air handling system, and an air outlet.

The embodiment illustrated in FIG. 1 includes an exemplary air handling system which comprises an Ozone Catalyst 40 and a Fan 50, described in greater detail below. One having ordinary skill in the art will appreciate that the air handling system is configured to control the airflow through the WEPA Purifier 1, and may comprise additional or alternative components known in the art which are adapted to manage/control airflow. In addition, one having ordinary skill in the art will appreciate that the particular embodiment illustrated in FIG. 1 is exemplary in nature, and that alternative air handling systems and components thereof should be considered within the scope of the present invention.

In operation, the WEPA Purifier 1 is configured to receive contaminated air 5, purify the air, and exhaust the purified air 100 into an environment or space where the clean air is needed. As used herein, the term “contaminated air” includes an amount of air which includes at least one particulate. One having ordinary skill in the art will appreciate that the contaminated air generally includes a plurality of both large and small particulates, wherein the particulates are hazardous. As used herein, the term purified air is intended to include the air that is exhausted from the WEPA purifier 1 that includes a reduced amount or level of particulates as compared to the contaminated air 5. According to a preferred embodiment of the present invention, the purified air 100 may comprise 50% less particulates as compared to the contaminated air 5. Even more preferably, the purified air 100 may have 99.99% less particulates as compared to the contaminated air 5. One having ordinary skill in the art will appreciate that the term ‘purified air’ as used herein is in no way limited in terms of the purity level or specific level of particulates.

Referring to FIG. 1, the contaminated air 5 enters into the WEPA Purifier 1 through an air inlet and into a pre-conditioning chamber. According to an embodiment of the present invention, the pre-conditioning chamber comprises a Large Particulate Inertial Separator 10 and a Flow Straightener 20. One having ordinary skill in the art will appreciate that similar, alternative, and/or additional components may be included in the pre-conditioning chamber, depending on the design requirements of the purification system.

According to an embodiment of the present invention, the Large Particulate Inertial Separator 10 is arranged in fluid communication with the inlet and receives the contaminated air 5. The Large Particulate Inertial Separator 10 is configured to remove particulate greater than approximately 50 μm particle diameter (i.e., large particulates) from the contaminated air 5. This is done, in part, to ensure the reliability of the water pumping system used to re-circulate the liquid media (i.e., solution) used to capture and disinfect the inlet aerosol. One having ordinary skill in the art will appreciated that large particulate inertial separators are known in the art. Any suitable large particulate inertial separator may be used in accordance with the present invention.

Next in the air flow path is the Flow Straightener 20, which is arranged in fluid communication with the Large Particulate Inertial Separator 10. According to an embodiment of the present invention, the Flow Straightener 20 comprises an array of parallel tubes configured to create a laminar airflow at the input of the Wet Electrostatic Precipitator 30. The airflow is mechanically conditioned by the Flow Straightener 20 to assure laminar and orderly motion of the air stream as it enters the Wet Electrostatic Precipitator 30. One having ordinary skill in the art will appreciate that the operation of the Wet Electrostatic Precipitator 30 is optimized for laminar flow conditions.

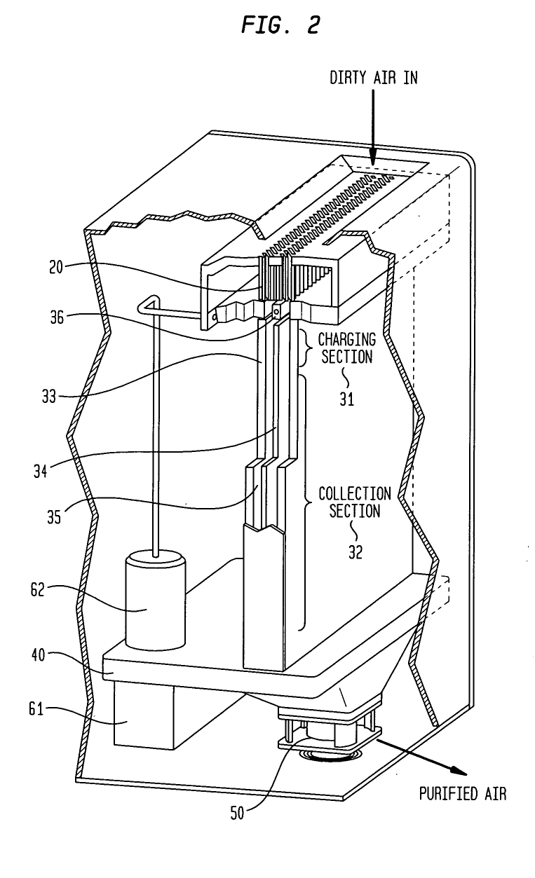

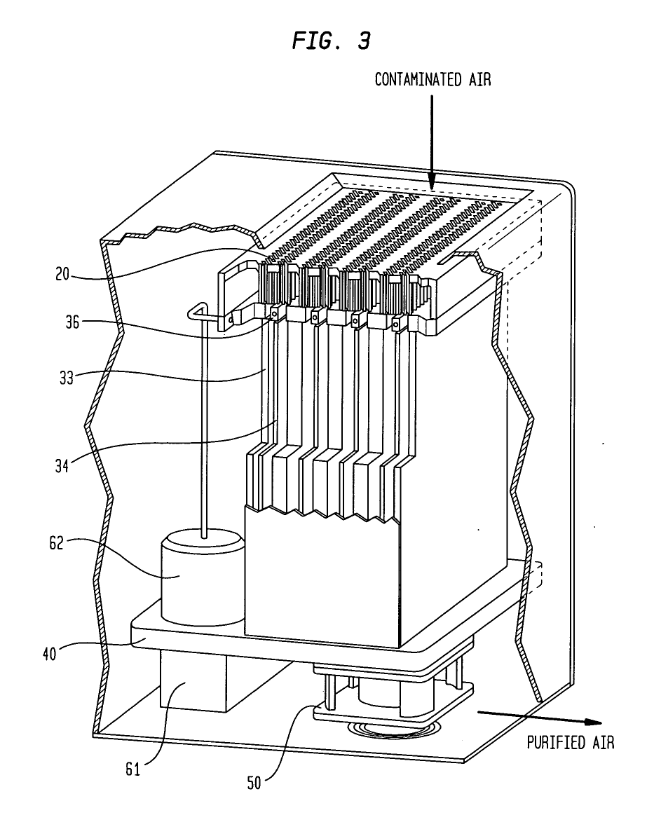

FIG. 2 illustrates a WEPA Purifier 1 comprises a single Wet Electrostatic Precipitator 30 module. A multiple module purifier is described in detail below with respect to FIG. 3. Referring to FIG. 2, the Wet Electrostatic Precipitator 30 is arranged in fluid communication with the Flow Straightener 20, and is adapted to receive the laminar aerosol therefrom. One having ordinary skill in the art will appreciate that the Wet Electrostatic Precipitator 30 may be any suitable shape. According to a preferred embodiment, the Wet Electrostatic Precipitator 30 is configured as a rectangular duct through which a laminar aerosol is drawn.

According to an embodiment of the present invention, the Wet Electrostatic Precipitator 30 comprises a particle capture zone which is partitioned in two main sections: a charging section 31 and a collection section 32. The charging section 31 includes a corona array 33 comprising at least one row of corona discharge electrodes. One having ordinary skill in the art will appreciate that the corona array 33 may comprise any suitable number of rows and that, furthermore, each row may comprise any suitable number of corona discharge electrodes. Preferably, the corona array 33 is arranged at the entrance of the Wet Electrostatic Precipitator 30.

The collection section 32 comprises a grounded wetted collection plate 34 (herein referred to as the “collection plate”) and at least one field electrode 35. According to an embodiment of the present invention, the corona array 33 is spaced apart from the collection plate 34 by any suitable distance, such as, for example, approximately 12.5 mm.

In operation, a high DC voltage is applied between the corona discharge electrodes and the collection plate 34 to create a corona discharge at each electrode tip. The spatial uniformity and charge density of the charging section 31 is particularly important in air purification applications. This is because of the requirement to have particle removal efficiencies similar to those of a HEPA filter. High particle capture efficiencies similarly require all particles are charged before entering the collection section 32. The charging section 31 of the present invention is adapted to achieve high density, high uniformity charging.

The corona charging technique used herein is described in greater detail in the following related applications, all of which are herein incorporated by reference: U.S. application Ser. No. 10/386,252, filed Mar. 11, 2003, titled “Corona Charging Device And Methods”; U.S. application Ser. No. 10/603,119, filed Jun. 24, 2003, titled “Method And Apparatus For Concentrated Airborne Particle Collection”; U.S. application Ser. No. 11/140,124, filed May 27, 2005, titled “Method And Apparatus For Airborne Particle Collection”; U.S. Application No. 60/672,821, filed Apr. 19, 2005, titled “Spatially Selective Particulate Deposition And Enhanced Particulate Deposition Efficiency”; and U.S. Application No. 60/673,013, filed Apr. 19, 2005, titled “Atmospheric Corona Discharge Mechanism As Method For Creating Spatially Selective Particulate Deposition And Enhanced Particulate Deposition Efficiency.”

Referring back to FIG. 2, as the particles pass through the charging section 31, the corona discharge applies a charge to each of the particles. Next, the charged particles pass into the collection section 32. In the collection section 32, a voltage of the same polarity as that used to create the corona discharge is applied to the field electrode 35. This produces an electric field between the field electrode 35 and the collection plate 34 which pushes or drives the charged particles through the air stream to the collection plate 34.

According to an embodiment of the present invention, the collection plate 34 comprises a surface wetted by a capturing solution, herein referred to as the collection surface. One having ordinary skill in the art will appreciate that the collection surface may be wetted with any suitable capturing solution. According to a preferred embodiment of the present invention, the capturing solution comprises water. Even more preferably, the collection surface is wetted by a water-bleach solution adapted to carry and disinfect the collected particles away from the collection plate and eliminate the efficiency-reducing effects due to the back-ionization at the collection surface.

According to an embodiment of the present invention, the capturing solution is provided to the collection surface by the re-circulating solution system 60, shown in FIG. 1. In addition to wetting the collection surface with the capturing solution, the re-circulating solution system 60 is configured to receive the captured threat particles, where the particles are rendered harmless and retained

Uniformly wetting the surface of the collection plate is particularly important for achieving particle capture efficiencies equivalent to that of a HEPA filter. As such, the collection plate 31 is optimally composed of a material particularly suited for uniform wetting, such as, for example, sintered titanium subjected to an oxidation process to create a hydrophilic surface. The wetting property of the modified titanium surface provides enhanced capillary forces that helps spread the fluid uniformly across the pores of the sintered material producing a robust method of solution coverage over the collection plate 31.

According to an embodiment of the present invention, the capturing solution comprises water which is pumped from a main reservoir 61 of the re-circulating solution system 60 to a top end of the collection plate 34, where it is distributed uniformly across the collection surface, as shown in FIG. 2. Optionally, the Wet Electrostatic Precipitator 30 may comprise a solution distribution manifold 36 configured to control the distribution of the solution onto the collection surface in a uniform manner. The solution (e.g., water) introduced through the manifold 36 atop the collection plate wets both collecting surfaces and transports the particles to the bottom of the collection plate for removal. According to an embodiment of the present invention, the capturing solution may comprise a water-concentrated disinfectant solution, such as, for example, sodium hypochlorite (i.e., bleach). In this case, the disinfectant may be supplied by an ancillary reservoir of the re-circulating solution system 60 to combine with the water of the main reservoir 60 to form the water-disinfectant capturing solution.

Next, the particles are captured in the solution flowing over the collection surface and transported to the main reservoir 61 by the force of gravity. For example, as shown in FIG. 2, the input air is split into two channels separated by a two-sided collection electrode. The two outer plates contain corona arrays at the intake and repelling electrodes along the airflow. Water introduced through the manifold 36 atop the collection electrode wets both collecting surfaces and transports particles to the bottom for removal.

According to an embodiment of the present invention, the Wet Electrostatic Precipitator 30 eliminate the efficiency-reducing effects caused by particle re-entrainment and back-ionization due to particulate buildup at the collection surface. This technique is well known in the art and may be found in several conventional systems designed for industrial air pollution control. The Wet Electrostatic Precipitator 30 of the present invention is particularly suited to meet the HEPA-like collection performance due to its ability to produce a high-intensity ion zone needed to charge all the particles, and the robust nature of the collection plate 31 that allows for highly efficient particle collection.

According to one example, the Wet Electrostatic Precipitator 30 may be configured as a rectangular-shaped duct having any suitable dimensions, such as for, example, 12 inches wide by 1 inch deep by 12 inches in length. These exemplary dimensions correlates to a linear air velocity of 2.2 meters/second. The air velocity is a critical design parameter for effective particle capture and removal, and may be used by one having ordinary skill in the art when determining the dimensions of the Wet Electrostatic Precipitator 30. As shown in FIG. 1, the Wet Electrostatic Precipitator 30 may be connected to suitable electronics for sustaining a high-density, uniform corona discharge, such as, for example, a conventional HV DC power source and an ion current control component 70.

According to an embodiment of the present invention, the WEPA Purifier 1 is scalable, and may include a plurality of Wet Electrostatic Precipitator 30 modules, as shown in FIG. 3. The scaleable design of the WEPA Purifier 1 allows it to accommodate varying flow requirements. To achieve higher airflow rates, a plurality of Wet Electrostatic Precipitator 30 modules may be arranged in parallel to increase the width of the flow, while maintaining the same flow velocity. The increase in parallel modules is proportional to the desired increase in air volume to be purified. According to an exemplary embodiment of the present invention, each Wet Electrostatic Precipitator 30 module may be configured to purify approximately 1,000 LPM of air (˜35 cfm).

As shown in FIGS. 1, 2, and 3, the WEPA Purifier 1 further comprises an air handling system configured to control the airflow through the WEPA Purifier 1. According to an embodiment of the present invention, the air handling system comprises an Ozone Catalyst 40 arranged in fluid communication with the at least one Wet Electrostatic Precipitator 30. The Ozone Catalyst 40 is a component of the liquid and air-handling compartment, and is configured to receive exhaust air comprising ozone produced by the corona discharge in the charging section of the Wet Electrostatic Precipitator 30. The ozone generated in the charging process is removed by the Ozone Catalyst 40, which converts the ozone into oxygen and water.

The FDA-recommended safe ozone concentration for a space occupied by humans for an eight-hour shift is approximately 50 ppb. As such, the Ozone Catalyst 40 of the present invention is designed to reduced the ozone level to below 50 ppb. One having ordinary skill in the art will appreciate that any suitable ozone catalyst may be used in accordance with the present invention, such as, for example, the Carulite 200, a readily available product produced by the Carus Chemical Company. The Carulite 200 material is an extruded mixture of manganese dioxide and copper oxide and is typically used for ozone capture applications such as potable water off-gas emissions, office equipment emissions, and corona treatment emissions. According to an embodiment of the present invention, the Ozone Catalyst 40 is capable of ozone removal efficiency approximately equal to greater than 99% in a configuration that results in a low pressure drop of 1.5 inches water column across the catalyst bed. The expected lifetime of the catalyst material is approximately four years for indoor environments.

According to an embodiment of the present invention, the air handling system further comprises a Fan 50. The Fan 50 is arranged in fluid communication with the Ozone Catalyst 40, and is configured to supply a differential pressure to move the air through the air flow path to the air outlet. One having ordinary skill in the art will appreciate that the addition of the Ozone Catalyst 40 increases the power requirement for the Fan 50 needed to draw air through the system. The pressure drop through the air inlet, the pre-conditioning chamber, and the Wet Electrostatic Precipitator 30 are negligible compared to the 1.5 in. wg. needed for the Ozone Catalyst 40. As such, for example, the Fan 50 power required for a 4,000 LPM (˜150 cfm) airflow is approximately 100 W. One having ordinary skill in the art will appreciate that any suitable Fan 50 may be used in accordance with the present invention, such as, for example, the Newark Electronics centrifugal fan (which operates from a 56V DC power source). This exemplary Fan 50 is significantly smaller, quieter and requires less power than a blower fan needed for a comparable flow rate HEPA filter based purifier. As shown in FIG. 1, the Fan 50 may be connected to a Fan Power and Controls component 80 for providing power to the Fan 50 and for controlling the airflow velocity through the WEPA Purifier 1.

As described above, the WEPA Purifier 1 comprises a re-circulating solution system 90 configured to retain the captured particles and provide the capturing solution to the Wet Electrostatic Precipitator 30. According to an embodiment of the present invention, the re-circulating solution system 90 comprises a main reservoir 61, re-circulation pump 62, a regenerative liquid filter, and an ancillary reservoir for containing a concentrated disinfectant (e.g., sodium hypochlorite (bleach)).

In operation, the threat particles captured by the Wet Electrostatic Precipitator 30 are provided to the re-circulating solution system 60 where they are rendered harmless and retained. Water from the main reservoir 61 is fed to the at least one collection plate 31 by a re-circulation pump 62. Collection of particulates into the water occurs as it flows down the collection plates, as described in detail above. At the bottom of the collection plate(s), the water is collected, forced through the regenerative liquid filter, and returned to the main reservoir 61. As such, filtration occurs prior to re-entering the main reservoir 61 to ensure all particles, including radioactive ones, are captured at this point thus eliminating sedimentation of the particles within the main reservoir 61. Periodic metering of a disinfectant is dispensed through the primary filter to ensure a high exposure of captured biological threats to the disinfectant.

According to an embodiment of the present invention, the regenerative liquid filter is configured to retain the captured particulates and has the capacity to hold such particulates for along period of time (e.g., approximately 12 months), even from the dustiest environments. One having ordinary skill in the art will appreciate that any suitable regenerative liquid filter may be used in accordance with the present invention. Advantageously, under typical conditions, the regenerative liquid filter doe not need to be replaced, it simply needs to be back-flushed periodically (e.g., once a year), to remove the already destroyed, non-hazardous particles.

In the event that the WEPA Purifier 1 has been used in a radioactive environment and collected radioactive particles, all the particulates will be sequestered within the liquid filter and then can be properly disposed. For radioactive environments an optional lead-shielded holder can be placed around the regenerative liquid filter to provide protection to the personnel and minimize human exposure.

Optionally, differential pressure monitors may be used to monitor the regenerative liquid filter and provide a warning when regenerative liquid filter requires maintenance. The design for the regenerative filter capacity was based on the calculation for the quantity of dust typically present in a mining environment, and that value was doubled. Also, under typical conditions the regenerative liquid filter does not need to be replace, it simple needs to be back-flushed, once a year, to remove the already destroyed, non-hazardous particles.

One having ordinary skill in the art will appreciate that any suitable regenerative liquid filter may be used in accordance with the present invention, such as, for example, commercially available cartridge-type filters.

Water consumption was calculated using the work of Kawamura and Mackay. At 20° C., 30% RH, and an airflow velocity of 2.2 m/s (i.e., 1,000 liters/min) over the two 12″×12″ collection plates of a single module, water consumption is 17 ml/hour or 400 ml/day. For a unit as in FIG. 3 consisting of four precipitator modules with a 4000 liter/minute capacity, water consumption is 1.4 liters/day. A 10″ cube contains sufficient water for a week's operation with a 5-liter reserve. A 0.5% sodium hypochlorite solution is typically specified for disinfections with a correspondingly smaller requirement for the ancillary reservoir.

According to an exemplary embodiment of the present invention, the throughput of the WEPA Purifier 1 is estimated to be approximately 4,000 liters per min (140 cubic feet per minute). At this flow rate, the air within a room 30′×20′×8′ may be exchanged approximately twice per hour. According to an embodiment of the present invention, the WEPA Purifier 1 may be approximately 3.4 ft³, and occupy a space approximately 1.5 ft×1.5 ft×1.5 ft. According to an embodiment of the present invention, the approximate power consumption for the WEPA Purifier 1 is 150 W.

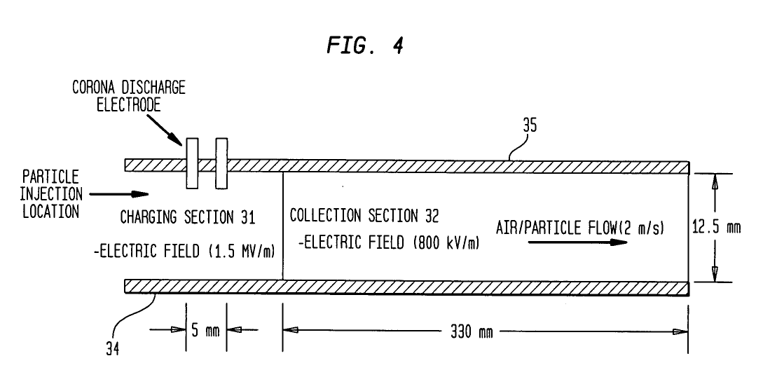

Using a mathematical simulation, a prediction of WEPA particle capture efficiency was conducted. The mathematical model calculated particle trajectories during transit through the Wet Electrostatic Precipitator 30. Referring to the schematic shown in FIG. 4, the particles enter the Wet Electrostatic Precipitator 30 at the left hand side of the Figure, traveling at a velocity equal to the airflow velocity. The particle is then charged in the charging section 31 by the free ions produced by the corona electrodes, as described in detail above. In both the charging section 31 and the collection section 32, the charged particle is forced toward the collection plate 34 by the electric field between the top of the duct of the Wet Electrostatic Precipitator 30 and the collection plate 34.

Generally, a particle is considered ‘captured’ if its trajectory intersects the grounded collection surface for a given precipitator length. The model allows particles to be injected at different vertical distances above the collection plate 34. This feature calculates the maximum height at which a particle entering the precipitator will be captured for a given precipitator length. If the flux of particles entering the Wet Electrostatic Precipitator 30 are assumed to be uniformly distributed across the inlet, then the results of this modeling may be used to predict the particle-capture efficiency for a range of particle sizes and other variable precipitator operating conditions, such as, for example, ion current densities, electric field potentials in the collection section 31, and the collection section 31 length.

One having ordinary skill in the art will appreciate that mathematical modeling of the particle trajectories is a complicated problem involving both the fluid dynamic and electrostatic properties of the system. In order to simplify the modeling, the following assumptions were made to reduce the complexity of the computations: laminar flow throughout the collection tube; constant air and particle velocity in the flow direction neglecting the boundary layer perturbations at the corona electrodes; instantaneous acceleration of particles to terminal velocity due to the electric field force and charging; uniform corona generation in the charging zone neglecting the electrodes as point sources; expansion of the ion beam at the leading and trailing edges of the collection zone is neglected; no compensation is performed to estimate the electric field in the transition region isolating the charging section 31 from the collection section 32; field charging is the only method used to predict the particle charging performance.

The model uses the known Pauthenier and Stokes equations combined with an estimate of the electric field to numerically derive particle position given an entry position of the particle above the collection plate. A first order approximation of the charge density, electric field, and particle charging level are combined to compute the vertical particle velocity and position. The particle velocity in the direction of flow is directly computed from the average air velocity input to the model.

The model is very flexible in terms of describing system performance with respect to varying input parameters. The inputs used to describe the system are volumetric airflow, ion current density, duct height, duct length, particle diameter, and average electric field. The outputs that can be extracted from the model include particle position, particle velocity, particle charging as percent saturation of the maximum particle charge, collection surface landing position, and electrical power needed for operating the electrostatic circuits.

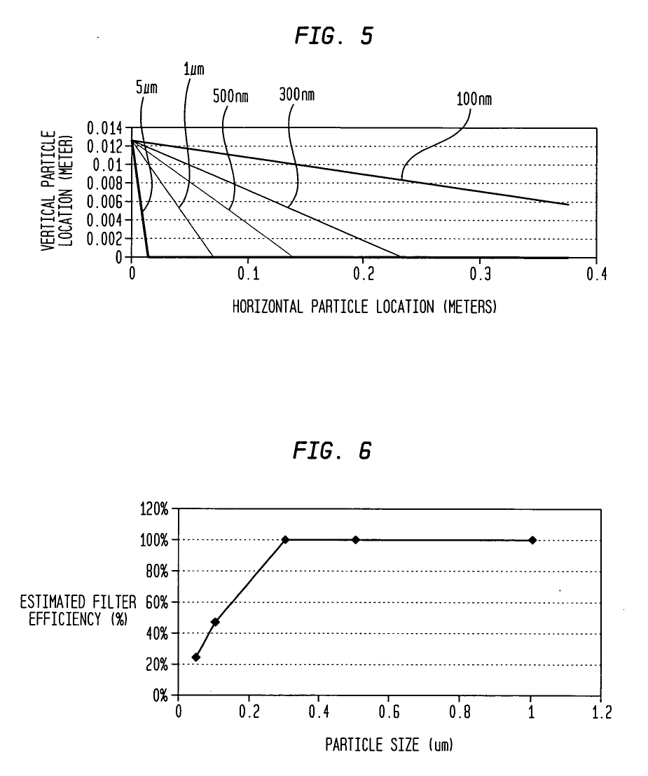

FIG. 5 shows an example of the particle trajectories for particles ranging in size from approximately 100 nm to approximately 5 μm. The vertical axis of the plot indicates the vertical position of a particle above the collection plate during its transit through the precipitator. The dimension of this axis is meters. For the simulation results shown above, particles of different sizes were injected into the precipitator at a height of 12.5 mm above the collection plate. This is the maximum vertical distance a particle would have to travel before intersecting with the collection surface. The vertical height of the collection plate is zero.

The horizontal axis in the graphic represents the distance into the duct a particle has traveled due to the drag force of the air. The dimension of this axis is meters. The duct length is designed to be approximately 33 cm. The horizontal entry position of all particles is zero. If a particle's trajectory intersects the collection plate (i.e., vertical position equal to zero) and the horizontal position of the particle is less than 33 cm, the particle is assumed captured.

As an example, the plot in FIG. 6 illustrates that the precipitator is capable of capturing all particles with a diameter greater than or equal to 300 nm. The trajectory for the 100 nm particles entering the duct at a height 12.5 mm above the collection plate are not captured and exit the precipitator with the airflow. The height at which particles are captured for a 33 cm duct length has been calculated for particle diameters ranging from 50 nm to 1 μm and the result of this calculation is shown in FIG. 6. Assuming uniform distribution of particles across the duct opening, this height represents the efficiency of capturing that size particle.

FIG. 6 shows the capture efficiency for particles whose diameter range from 50 nm to 1 μm. The collection efficiency for 50 nm particles is approximately 24%, and for 100 nm particles is approximately 47%. The collection efficiency for all particles greater than or equal to 300 nm diameter is 100%.

Because of gaps in the charging zone and turbulence in the duct, actual collection efficiencies generally do not reach 100%, but are expected to be >99.99% for particles 300 nm and greater.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. An air purification system for purifying contaminated air comprising particulates comprising:
an inlet for receiving the contaminated air comprising particulates;
at least one wet electrostatic precipitator module in fluid communication with the inlet, wherein the wet electrostatic precipitator is configured to produce purified air by capturing the particulates in a capturing solution;
a re-circulating solution system in fluid communication with the wet electrostatic precipitator, wherein the re-circulating solution system is configured to:
provide the capturing solution to the wet electrostatic precipitator,
receive the captured particulates from the at least one wet electrostatic precipitator module, and
retain the captured particulates; and
an outlet in fluid communication with the wet electrostatic precipitator module to deliver the purified air to an environment.

2. The air purification system of claim 1, further comprising a pre-conditioning chamber in fluid communication with and positioned between the inlet and the at least one wet electrostatic precipitator module, wherein the pre-conditioning chamber is configured to condition the contaminated air prior to introduction to the at least one wet electrostatic precipitator module.

3. The air purification system of claim 2, wherein the pre-conditioning chamber comprises:
a large particulate inertial separator in fluid communication with the inlet, wherein the large particulate inertial separator removes large particulates from the contaminated air; and
a flow straightener in fluid communication with the large particulate inertial separator, wherein the flow straightener is configured to produce substantially laminar airflow for input into the at least one wet electrostatic precipitator module.

4. The air purification system of claim 1, wherein the at least one wet electrostatic precipitator module comprises:
a charging section comprising a corona array, wherein the corona array is configured to produce a corona discharge which applies a charge to the particulates of the contaminated air; and
a collection section comprising a collection plate and a field electrode, wherein an electric field between the field electrode and the collection plate pushes the charged particles to the collection plate and the charged particles are collected in the capturing solution.

5. The air purification system of claim 1, further comprising an air handling system configured to control the flow of air through the air purification system.

6. The air purification system of claim 5, wherein the air handling system comprises:
an ozone catalyst in fluid communication with the at least one wet electrostatic precipitator module, wherein the ozone catalyst is configured to convert ozone generated by the at least one wet electrostatic precipitator module into oxygen and water; and
a fan in fluid communication with the ozone catalyst and the outlet, wherein the fan is configured to facilitate the flow of the purified air to the environment.

7. The air purification system of claim 1, wherein the re-circulating solution system comprises:
a reservoir system configured to store the capturing solution;
a pump in fluid communication with the reservoir system, wherein the pump is configured to deliver the capturing solution to the collection plate; and
a regenerative liquid filter in fluid communication with collection plate, wherein the regenerative liquid filter is configured to retain the captured particulates received from the at least one wet electrostatic precipitator.

8. The air purification system of claim 7, wherein the reservoir system comprises a main reservoir configured to store water.

9. The air purification system of claim 8, wherein the reservoir system comprises a disinfectant reservoir in fluid communication with main reservoir, the disinfectant reservoir containing a disinfectant that may be combined with the water stored in the main reservoir to produce the capturing solution.

10. The air purification system of claim 9, wherein the capturing solution is a water-bleach solution.

11. The air purification system of claim 7, wherein a lead-shielded holder is arranged at least partially around the regenerative liquid filter to provide protection from at least one particulate comprising radioactive material.

12. The air purification system of claim 4, further comprising a solution distribution manifold to substantially uniformly distribute the capturing solution onto the collection plate.

13. The air purification system of claim 1, further comprising a plurality of wet electrostatic precipitator modules arranged in parallel.

14. A method of purifying contaminated air having particulates, the method comprising the steps of:
receiving contaminated air comprising particulates;
applying a charge to the particulates;
wetting a collection plate with a capturing solution;
collecting the charged particulates in the capturing solution, thereby producing purified air;
transporting the capturing solution having the particulates to a reservoir;
retaining the captured particulates in a regenerative liquid filter; and
delivering the purifier air to an environment.

15. The air purification method of claim 14, further comprising the step of pre-conditioning the contaminated air.

16. The air purification method of claim 15, wherein the step of pre-conditioning the contaminated air comprises removing large particulates from the contaminated air and straightening the contaminated air into a substantially laminar airflow pattern.

17. The air purification method of claim 14, wherein the charge is applied to the particulates by a corona discharge.

18. The air purification method of claim 14, wherein the collecting step further comprises generating an electric field between a field electrode and the collection plate to drive the charged particulates into the capturing solution.

19. The air purification method of claim 14, further comprising the step of converting ozone generated during the charging step into water and oxygen.

20. The air purification method of claim 14, wherein, following retention of the captured particulate in the regenerative liquid filter, the capturing solution is re-circulated to the collection plate.
